(19) United States
(12) Patent Application Publication
(10) Pub. No.: US 2024/0185115 A1
(43) Pub. Date: Jun. 6, 2024

(54) METHOD AND APPARATUS FOR EARLY WARNING OF DRY PUMP SHUTDOWN, ELECTRONIC DEVICE, STORAGE MEDIUM AND PROGRAM

(71) Applicant: BOE Technology Group Co., Ltd., Beijing (CN)

(72) Inventors: Qing ZHANG, Beijing (CN); Quanguo ZHOU, Beijing (CN); Lijia ZHOU, Beijing (CN); Jiuyang CHENG, Beijing (CN); Zhidong WANG, Beijing (CN); Ruwang GUO, Beijing (CN); Lirong XU, Beijing (CN); Junrui ZHANG, Beijing (CN); Xuehui ZHU, Beijing (CN); Meng GUO, Beijing (CN)

(21) Appl. No.: 17/795,276

(22) PCT Filed: Sep. 24, 2021
(86) PCT No.: PCT/CN2021/120378

§ 371 Date: Jul. 26, 2022

(51) Int. Cl. G06N 20/00; G06N 5/022

(52) U.S. Cl. CPC G06N 20/00; G06N 5/022

(57) ABSTRACT

The disclosure provides a method and apparatus for early warning of dry pump shutdown, an electronic device, a storage medium and a program, and belongs to the technical field of automatic control. The method comprises: obtaining historical operating data of a dry pump; building a Kalman filter model by using the historical operating data; predicting predicted operating data of the dry pump through the Kalman filter model; training a shutdown prediction model by using the historical operating data and the predicted operating data; and inputting current operating data of the dry pump into the trained shutdown prediction model to obtain shutdown early warning information of the dry pump.

### TECHNICAL FIELD

The present disclosure relates to the technical field of automatic controlling, and more particularly, to a method and an apparatus for early warning of dry pump shutdown, an electronic device, a storage medium and a program.

### BACKGROUND

A dry pump device is widely used in the panel industry, mainly providing various chambers with a reaction environment for vacuum coating, and is an indispensable auxiliary device in a display process. However, the dry pump shutdown may happen at any time, and the spare parts may not be properly managed, which will lead to problems such as losing control of product quality, passive managing of device management, and increasing maintenance cost, therefore, resulting in a series of capacity losses and economic losses.

### SUMMARY

The present disclosure provides a method and apparatus for early warning of dry pump shutdown, an electronic device, a storage medium and a program.

Some embodiments of the present disclosure provide a method for early warning of dry pump shutdown. The method includes:
obtaining historical operating data of a dry pump;
building a Kalman filter model by using the historical operating data;
predicting predicted operating data of the dry pump through the Kalman filter model;
and

training a shutdown prediction model by using the historical operating data and the predicted operating data;

inputting current operating data of the dry pump into the trained shutdown prediction model to obtain shutdown early warning information of the dry pump.

Optionally, the Kalman filter model is:

X=a₀t²+v₀t+x₀

X=At+B

wherein, X represents a vector matrix of the historical operating data, t represents a time matrix, A represents a transition matrix, B represents a random term, and a₀, v₀ and x₀ represent the dynamic parameters.

Optionally, after obtaining the historical operating data of the dry pump, the method further includes:

filtering invalid data in the historical operating data, wherein the invalid data include: at least one of an error value, a null value and a duplicate value.

Optionally, after obtaining the historical operating data of the dry pump, the method further includes:

normalizing the historical operating data to a target data field.

Some embodiments of the present disclosure provide an apparatus for early warning of dry pump shutdown. The apparatus includes:
a receiving module configured for obtaining historical operating data of a dry pump;
a training module configured for building a Kalman filter model by using the historical operating data;
predicting predicted operating data of the dry pump through the Kalman filter model; and
training a shutdown prediction model by using the historical operating data and the predicted operating data; and

an early warning module configured for inputting current operating data of the dry pump into the trained shutdown prediction model to obtain shutdown early warning information of the dry pump.

Optionally, the Kalman filter model is:

X=a₀t²+v₀t+x₀

X=At+B

wherein, X represents a vector matrix of the historical operating data, t represents a time matrix, A represents a transition matrix, B represents a random term, and a₀, v₀ and x₀ represent the dynamic parameters.

Optionally, the receiving module is further configured for:

filtering invalid data in the historical operating data, wherein the invalid data include: at least one of an error value, a null value and a duplicate value.

Optionally, the receiving module is further configured for:

normalizing the historical operating data to a target data field.

Some embodiments of the present disclosure provide a computing-processing device, including:
a memory in which a computer-readable code is stored; and
one or more processors, wherein when the computer-readable code is executed by the one or more processors, the computing-processing device executes the above-mentioned method for early warning of dry pump shutdown.

Some embodiments of the present disclosure provide a computer program including a computer-readable code, wherein the computer-readable code, when executed on a computing-processing device, causes the computing-processing device to execute the above-mentioned method for early warning of dry pump shutdown.

Some embodiments of the present disclosure provide a non-transitory computer-readable medium storing the above-mentioned method for early warning of dry pump shutdown.

The above description is merely a summary of the technical solutions of the present disclosure. In order to more clearly know the technical means of the present disclosure to enable the implementation according to the contents of the description, and in order to make the above and other objects, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the drawings that are required to describe the embodiments or the prior art will be briefly introduced below. Apparently, the drawings that are described below are embodiments of the present disclosure, and a person skilled in the art may obtain other drawings according to these drawings without paying creative work.

FIG. 1 schematically shows a flow chart of a dry pump provided by some embodiments of the present disclosure in a display panel manufacturing process;

FIG. 2 schematically shows a flow chart of a method for early warning of dry pump shutdown provided by some embodiments of the present disclosure;

FIG. 3 schematically shows a first schematic diagram of the method for early warning of dry pump shutdown provided by some embodiments of the present disclosure;

FIG. 4 schematically shows a second schematic diagram of the method for early warning of dry pump shutdown provided by some embodiments of the present disclosure;

FIG. 5 schematically shows a first flow chart of another method for early warning of dry pump shutdown provided by some embodiments of the present disclosure;

FIG. 6 schematically shows a second flow chart of another method for early warning of dry pump shutdown provided by some embodiments of the present disclosure;

FIG. 7 schematically shows a third schematic diagram of the method for early warning of dry pump shutdown provided by some embodiments of the present disclosure;

FIG. 8 schematically shows a fourth schematic diagram of the method for early warning of dry pump shutdown provided by some embodiments of the present disclosure;

FIG. 9 schematically shows a schematic structural diagram of an apparatus for early warning of dry pump shutdown provided by some embodiments of the present disclosure;

FIG. 10 schematically shows a block diagram of a computing-processing device for executing the method according to some embodiments of the present disclosure;

FIG. 11 schematically shows a storage unit for holding or carrying a program code for implementing the method according to some embodiments of the present application.

### DETAILED DESCRIPTION OF THE EMBODIMENTS

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

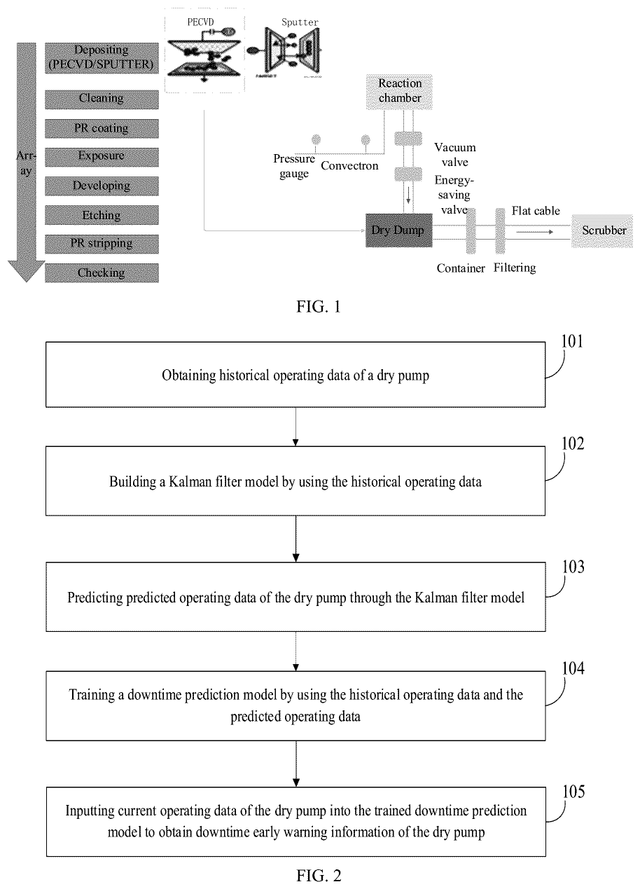

Referring to FIG. 1, a dry pump is widely used in the display panel industry, distributed in various processes (dry etching, PECVD, Sputter, EVEN, or the like), mainly providing a vacuum environment for a reaction chamber, and pumping out gas to realize a vacuum system of the reaction chamber, and realize a film-forming process. Taking an Array-PECVD process as an example, after the reaction gas enters a film-forming area, the reaction gas takes place a chemical reaction under a vacuum condition to form a film.

In the related art, maintenance methods for dry pumps mainly include active maintenance of device, regular replacement of spare parts, maintenance and repair after failure, or the like. These methods are inefficient, time-consuming, and costly, and is not capable to avoid influences on a production line after failure, and later emerged a threshold monitoring system using upper and lower limits of statistics to monitor an operating state of the dry pump. However, this method is greatly influenced by man-made operations, which causes many failures on results determining and lead to low accuracy and poor effect. With the continuous development of artificial intelligence, big data, Internet and other high-tech technologies, there are smarter, more labor-saving and more accurate solutions for monitoring a health status of the dry pump. This artificial intelligence monitoring system is highly dependent on data, but the prediction accuracy is very high.

FIG. 2 schematically shows a flow chart of a method for early warning of dry pump shutdown provided by the present disclosure. The method may be executed by a server or terminal device of an application program, and optionally, the method may be executed by the server. The method includes:

Step 101: obtaining historical operating data of a dry pump.

In the embodiment of the present disclosure, the dry pump refers to an oil-free dry mechanical vacuum pump, which may be divided into a dry screw vacuum pump and a dry scroll pump. The historical operating data refers to various operating index data of the dry pump obtained by testing an operating process of the dry pump in a past time period, such as current data, power data, temperature data, coolant flow rate, or the like, which may be applied to the embodiments of the present disclosure as long as the data may reflect the operating of the dry pump, and are not limited herein.

In practical application, the server may collect the operating data of the dry pump in the past time period through a detection device set in the dry pump for subsequent training and optimization of a shutdown prediction model.

For example, discussing on two dimensions which are data quality and data quantity. In terms of quality, data collection is in a frequency unit of minutes, and the operating data of multiple dimensions such as “current, power, temperature, and N₂ flow” (Table 1) are collected by sensors self-equipped with the dry pump and the data are extracted in order of time. Moreover, a vibration sensor is added to a motor and a gear or a corresponding position of the dry pump at a later stage to increase dimensions of the data collection. In terms of quantity, data of a full life cycle (full life cycle means a cycle from the date of installation of the dry pump to the date of shutdown, and to the date of next shutdown after maintenance and reinstallation) are collected on the basis of the quantity of dry pumps that may be added.

TABLE 1

| | | | | Purified | |
|---|---|---|---|---|---|
| | | Tempera- | | gas flow | |
| Current of | Speed of | ture of | Power of | of dry | |
| dry pump/ | dry pump/ | dry pump/ | dry pump/ | pump/ | |
| booster | booster | booster | booster | booster | Coolant |
| pump | pump | pump | pump | pump | flow rate |
| Exhaust | Operating | Warning | Warning | Exhaust | Gas inlet |
| tempera- | time | information | booster | pressure | pressure |
| ture | | of dry pump/ | | | |
| | | booster | | | |
| | | pump | | | |

Step 102: building a Kalman filter model by using the historical operating data.

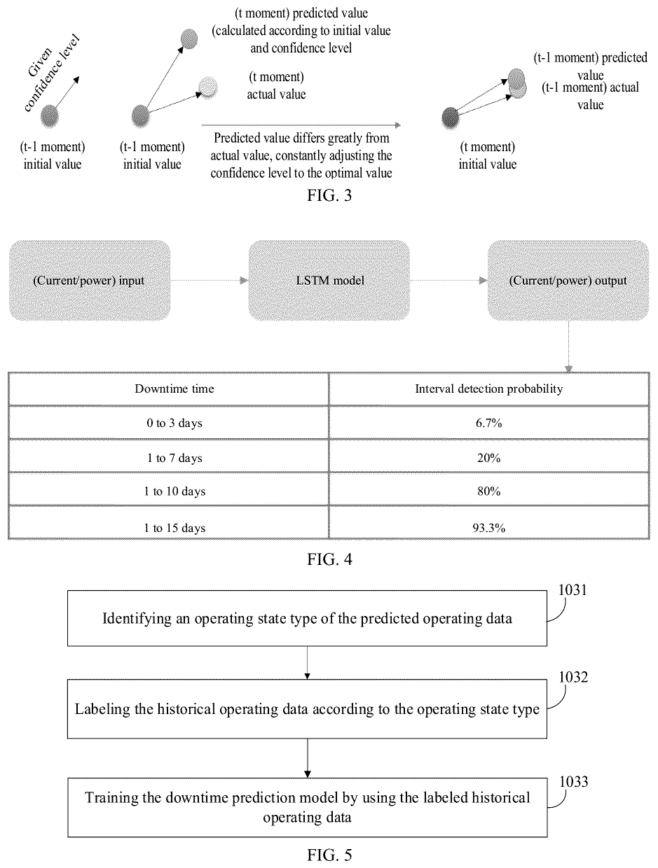

In the embodiment of the present disclosure, the Kalman filter model is an algorithm model that estimates a system state by inputting and outputting data observed by the system by means of using a linear system state mode. Specifically, the building of the Kalman filter model is divided into two stages: Firstly, after the dynamic parameters in the Kalman filter model are adjusted by inputting the historical operating data into the Kalman filter model, referring to FIG. 3, a value of a current time t is estimated by predicting a posterior estimation value of a previous time t-1, and is compared with an actual value in the historical operating data, and a confidence level of the Kalman filter model is adjusted according to a comparison value until an error between the predicted value and the actual value of the adjusted Kalman filter model reaches an expected requirement, and thus it may be determined that the Kalman filter model is built.

Step 103: predicting predicted operating data of the dry pump through the Kalman filter model.

In the embodiment of the present disclosure, the predicted operating data obtained by predicting the operating data of the dry pump at next moment through the Kalman filter model may reflect the operating situation of the dry pump at next moment. Taking a current as an example, in actual production, current data of the dry pump are constantly updated, and predicted current data may be obtained by the Kalman filter model in combination with a given confidence level. When the predicted current data are lower than an field associated with the confidence level, it indicates that the dry pump is at risk of shutdown.

Step 104: training a shutdown prediction model by using the historical operating data and the predicted operating data.

In the embodiment of the present disclosure, the shutdown prediction model may be a neural network model based on a Long Short-Term Memory (LSTM) algorithm. Because the Kalman filter model may filter noises and interferences in the operating data, the predicted operating data predicted by the Kalman filter model may reflect the future operating situation of the dry pump more accurately. Therefore, after the historical operating data is labeled based on the predicted operating data as a reference standard, and then input into the shutdown prediction model for prediction, the influences of the noises and interferences in the data on the prediction process of the shutdown prediction model may be effectively eliminated, and the shutdown prediction model may more accurately identify the shutdown risk of the dry pump.

For example, the historical operating data may be classified in different dimensions, and then divided into a training set and a verification set, then the first 10 to 15 values in each classified training set are taken, and a prior confidence level is continuously adjusted to a high level that meets the requirement through the Kalman filter model to obtain the predicted operating data. Then, the selected 10 to 15 values and the predicted operating data of the Kalman filter model are used as the final training set to train the shutdown prediction model, and then the verification set is used to train the trained shutdown prediction model, thus achieving the object of continuously optimizing the shutdown prediction model.

Step 105: inputting current operating data of the dry pump into the trained shutdown prediction model to obtain shutdown early warning information of the dry pump.

In the embodiment of the present disclosure, after the training of the shutdown prediction model is completed, the server may input the current operating data of the dry pump detected into the shutdown prediction model in real time, so that the shutdown early warning information may be obtained. Certainly, the shutdown prediction model usually identifies whether the predicted operating data of the dry pump may be down, therefore, shutdown-based information including whether there is a risk of shutdown of dry pump, a time period that the shutdown possibly occurs, reasons for shutdown, or the like, may be obtained by analyzing the predicted operating data that identifies the shutdown risk. For example, the dry pump may be down in next 1 to 10 days, or the dry pump may be down due to over-high temperature in next 1 to 10 days, which may be set according to the actual needs, and is not limited herein.

Further, referring to FIG. 4, taking current data and power data as examples, the algorithm model is built for different data, and the newly collected operating data may be continuously used to optimize and train the shutdown prediction model, so that an accurate algorithm model may be generated and accurate parameter prediction may be obtained.

According to the embodiment of the present disclosure, the shutdown operating data is predicted by the Kalman filter model built by using the historical operating data of the dry pump, so that the shutdown prediction model is trained by the obtained predicted operating data and the historical operating data, such that the shutdown prediction model may give consideration to the filtering characteristics of the Kalman filter model for noise and interference, identify the shutdown risk of the dry pump more stably, and improve the early warning accuracy of the dry pump shutdown.

Optionally, referring to FIG. 5, the step 103 may include:

Step 1031: identifying an operating state type of the predicted operating data.

Step 1032: labeling the historical operating data according to the operating state type.

Step 1033: training the shutdown prediction model by using the labeled historical operating data.

In the embodiments from step 1031 to step 1033 of the present disclosure, the operating state type is a type used to characterize the operating situation of the dry pump, such as a fault operating type, a normal operating type, an overload operating type, or the like, which may be set according to the actual needs, and is not limited herein.

As the predicted operating data may reflect the operating state of the dry pump in next moment of the historical operating data, parameter indexes in the predicted operating data may be analyzed to obtain the operating state of the dry pump in next moment, such as whether a shutdown occurs, a type of the reason for the shutdown, and the like. Therefore, the sample data obtained by labeling the operating state type in next moment may take into account the stability characteristics of the Kalman filter model, so that the subsequent shutdown prediction model may learn the stability characteristics of the Kalman filter model.

Optionally, the operating state type at least includes: a shutdown type and a normal type. The step 1031 may include:

A1: when the predicted operating data exceeds a normal operating data range, determining the predicted operating data as the shutdown type.

A2: when the predicted operating data does not exceed the normal operating data range, determining the predicted operating data as the normal type.

In the embodiment of the present disclosure, the predicted operating data may be screened through the preset normal operating data range of the dry pump during normal operating, and when the predicted operating data exceeds the range, it may be identified as the shutdown type with a shutdown risk, and if the predicted operating data does not exceed the range, it may be identified as the normal type without a shutdown risk.

Optionally, the shutdown type at least includes: a gradient abnormal type and a mutant abnormal type.

In the embodiment of the present disclosure, the shutdown type may be specifically a gradient abnormal type and a mutant abnormal type. The gradient abnormal type is used to reflect a shutdown type caused by the operating data gradually tending to abnormal values, such as a shutdown caused by factors such as a temperature of the dry pump gradually increasing and a pressure of a coating chamber connected with the dry pump gradually increasing. The mutant abnormal type is used to reflect a shutdown type that the operating data suddenly reaches abnormal values, such as a shutdown caused by factors such as a current of the dry pump suddenly increasing, sudden blockage of foreign bodies, sudden unavailability of dry pump parts due to aging, and the like.

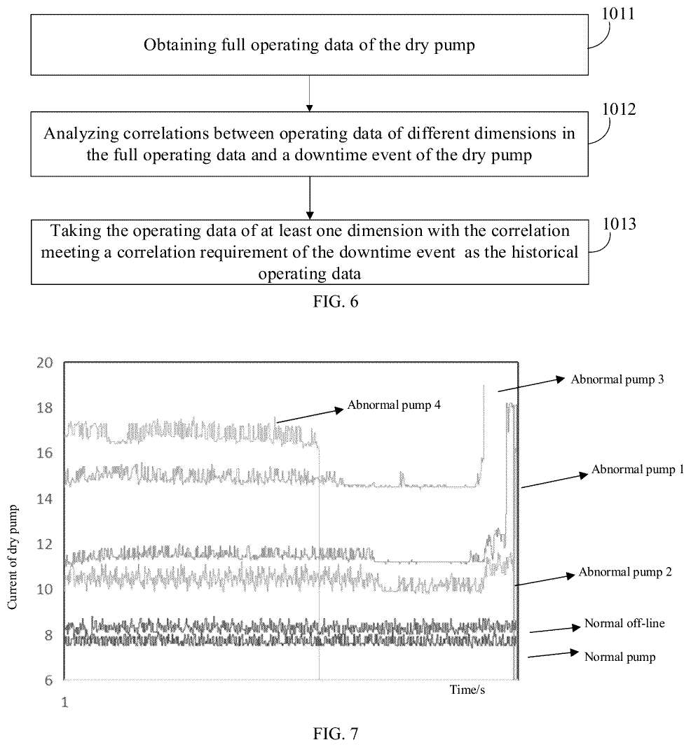

Optionally, referring to FIG. 6, the step 101 may include:

Step 1011: obtaining full operating data of the dry pump.

Step 1012: analyzing correlations between operating data of different dimensions in the full operating data and a shutdown event of the dry pump.

Step 1013: taking the operating data of at least one dimension with the correlation meeting a correlation requirement of the shutdown event as the historical operating data.

In the embodiment of the present disclosure, the full operating data of the dry pump refers to original data obtained by testing various dimensional parameters of the dry pump, which may contain data unrelated to the shutdown of the dry pump or with low correlation to the shutdown of the dry pump, so data with high correlation to the shutdown of the dry pump may be selected as input data for subsequent model training, thereby reducing data volume and data processing amount required for model training.

Optionally, the step 1012 may include:

C1: obtaining variation trends of the operating data of different dimensions in the full operating data near a shutdown time point of the dry pump.

C2: determining the correlations between the operating data of different dimensions and the shutdown event of the dry pump according to variation values of the variation trends.

In the embodiment of the present disclosure, the time is taken as an abscissa and the operating data is taken as an ordinate to draw a variation trend chart of the operating data of different dimensions, so that correlations of operating data of a plurality of dry pumps such as abnormal pumps, normal pumps and normal off-line pumps at the shutdown time are compared, so that the correlations between the operating data of different dimensions and the shutdown event of the dry pump may be obtained. For example, referring to FIG. 7, wherein an abscissa is the time and an ordinate is current data, it is found that the closer to the time point when the shutdown event occurs, the current data of abnormal pumps 1, 2, and 3 changes obviously compared with the current data of normal pumps and normal off-line pumps, indicating that the correlation between the current data and the shutdown event of the dry pump is higher.

Optionally, the step 1012 may include:

D1: building a multidimensional model of the operating data of different dimensions in the full operating data.

D2: obtaining measures of dispersion of the operating data of different dimensions in the multidimensional model.

D3: determining the correlations between the operating data of different dimensions and the shutdown event of the dry pump according to the measures of dispersion.

In the embodiment of the present disclosure, the multidimensional model, which may reflect the correlations of operating data of different dimensions, may be built by taking the operating data of some dimension as the abscissa and the operating data of other dimension as the ordinate, and the dimension of the multidimensional model is the same as the dimension of the operating data. Therefore, the correlation measures of dispersion between different dimensional parameters may be determined by the geometric multidimensional model. The higher the measures of dispersion, the greater the correlations between the dimensional parameters and the shutdown event of the dry pump.

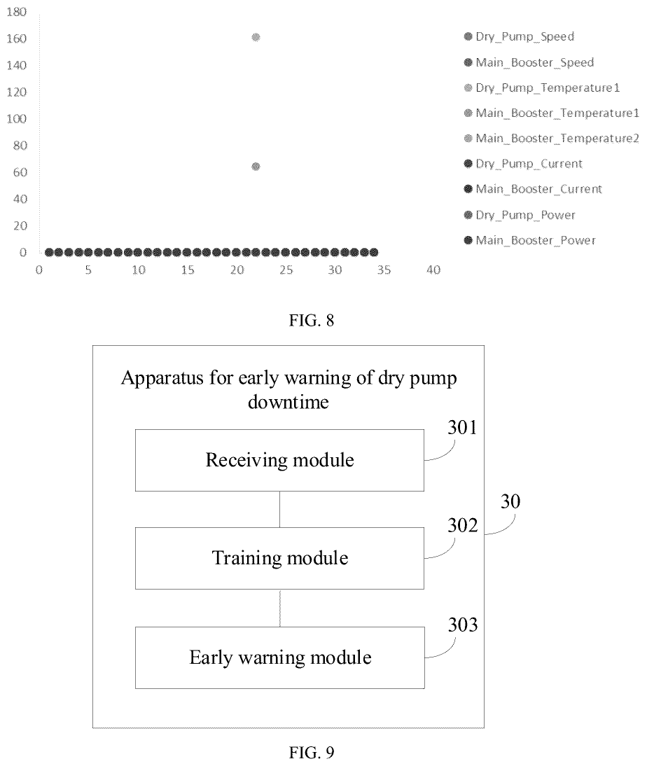

For example, referring to FIG. 8, an abscissa is the current data of the dry pump, and an ordinate is other dimension parameter. It may be seen that when the dry pump is down, operating data of a Dry_Pump_Temperature1 dimension and operating data of a Main_Booster_Temperature1 dimension are obviously more discrete than those of other dimensions, therefore, there is a great correlation between the operating data of these two dimensions and the dry pump shutdown.

Optionally, the step 102 may include: initializing dynamic parameters of the Kalman filter model; and adjusting the dynamic parameters in the initialized Kalman filter model by using the historical operating data until an execution degree of the adjusted Kalman filter model meets a building requirement.

In the embodiment of the present disclosure, for example, 5 to 15 partial values of the historical operating data may be taken first to initialize the Kalman filter, so that a prior confidence level of the Kalman filter to data distribution converges to a high level. A position and a confidence level of next data point are estimated according to model state estimation. If a predicted value differs greatly from an actual value in the historical operating data, the confidence level needs to be adjusted and optimized to the optimal, so that the final predicted value is basically consistent with the actual value, and an accuracy rate is equal to a number of detected shutdown failures divided by a total number of actual shutdown failures.

Optionally, the Kalman filter model is:

X=a₀t²+v₀t+x₀

X=At+B

wherein, X represents a vector matrix of the historical operating data, t represents a time matrix, A represents a transition matrix, B represents a random term, and a₀, v₀ and x₀ represent the dynamic parameters.

In the embodiment of the present disclosure, it may be determined through data analysis that the operating data of two dimensions have the highest correlation with the dry pump shutdown, and a second-order equation X=a₀t²+V₀t+x₀ may be used as a prediction formula of the Kalman filter model finally through a simulated displacement velocity formula that

$$\\ \frac{dX}{dt} = At + {v}_{0} .$$

In order to determine the dynamic parameters, X is defined as a dimensional space matrix X=At+B, namely the following formula (1):

$$\\ \begin{matrix}\begin{matrix}{X}_{1} \\ {X}_{2}\end{matrix} = [ \begin{matrix}a & b \\ c & d\end{matrix} ] \begin{matrix}{t}_{1} \\ {t}_{2}\end{matrix} + \begin{matrix}e \\ f\end{matrix} & ( 1 )\end{matrix}$$

wherein a, b, c and d represent parameters in the transition matrix A, which is generally checked from an identity matrix in the early stage, and e and f represent random variables in the random term B. For example, when a current of the dry pump is 7.9 A in 1 s, and a current of a booster pump is 4.3 A in 1 s, it may be determined that 7.9=a+2b+e and 4.3=c+2d+f by substituting the values into the two-dimensional matrix, and the Kalman filter model may be updated through iteration of multiple sets of data.

Optionally, after the step 101, the method may further include: filtering invalid data in the historical operating data, wherein the invalid data include: at least one of an error value, a null value and a duplicate value.

In the embodiment of the present disclosure, the operating data sorted by time is organized. Since there are some null values before the shutdown, and parameters such as power and current may suddenly change to 0 in general when shutdown occurs, insignificant values such as the error value, the null value and the duplicate value are deleted by machine screening in combination with related algorithms. For example, the collected historical operating data may be expressed in the form of Table 2:

TABLE 2

| | | | Temperature | | Current of | |
|---|---|---|---|---|---|---|
| | | Speed of dry | of dry | Power of dry | dry | |
| | Triggering | pump/booster | pump/booster | pump/booster | pump/booster | |
| idName | time | pump | pump | pump | pump | . . . |
| PUMP- | 01:26:44, | 100/99.9 | 159.4/76.4 | 4.4/1.1 | 8.3/3.5 | . . . |
| A-CHC-2 | Nov. 1, 2020 | | | | | |

. . .

| | | | | | | |
|---|---|---|---|---|---|---|
| 3APTE02- | 06:37:00, | 0/0 | 161.1/64.5 | 0/0 | 0/0 | . . . |
| CHC-2 | Nov. 20, 2020 | | | | | |

Optionally, after the step 101, the method may further include: normalizing the historical operating data to a target data field.

In the embodiment of the present disclosure, the collected historical operating data are standardized, and the values of the data are converted into a fixed field of [a, b], which contributes to the subsequent convergence process of the model and may improve the accuracy of the shutdown prediction model.

FIG. 9 schematically shows a schematic structural diagram of apparatus for early warning of dry pump shutdown 30 provided by the present disclosure. The apparatus includes:

a receiving module 301 configured for obtaining historical operating data of a dry pump;

a training module 302 configured for building a Kalman filter model by using the historical operating data;

predicting predicted operating data of the dry pump through the Kalman filter model; and

training a shutdown prediction model by using the historical operating data and the predicted operating data; and

an early warning module 303 configured for inputting current operating data of the dry pump into the trained shutdown prediction model to obtain shutdown early warning information of the dry pump.

Optionally, the training module 302 is further configured for:
identifying an operating state type of the predicted operating data;
labeling the historical operating data according to the operating state type; and
training the shutdown prediction model by using the labeled historical operating data.

Optionally, the operating state type at least includes: a shutdown type and a normal type; and

the training module 302 is further configured for:

when the predicted operating data exceeds a normal operating data range, determining the predicted operating data as the shutdown type; and

when the predicted operating data does not exceed the normal operating data range, determining the predicted operating data as the normal type.

Optionally, the shutdown type at least includes: a gradient abnormal type and a mutant abnormal type; and

optionally, the receiving module 301 is further configured for:

obtaining full operating data of the dry pump;

analyzing correlations between operating data of different dimensions in the full operating data and a shutdown event of the dry pump; and

taking the operating data of at least one dimension with the correlation meeting a correlation requirement of the shutdown event as the historical operating data. Optionally, the training module 302 is further configured for:

obtaining variation trends of the operating data of different dimensions in the full operating data near a shutdown time point of the dry pump; and

determining the correlations between the operating data of different dimensions and the shutdown event of the dry pump according to variation values of the variation trends.

Optionally, the training module 302 is further configured for:
building a multidimensional model of the operating data of different dimensions in the full operating data;
obtaining measures of dispersion of the operating data of different dimensions in the multidimensional model; and
determining the correlations between the operating data of different dimensions and the shutdown event of the dry pump according to the measures of dispersion.

Optionally, the training module 302 is further configured for:
initializing dynamic parameters of the Kalman filter model; and
adjusting the dynamic parameters in the initialized Kalman filter model by using the historical operating data until an execution degree of the adjusted Kalman filter model meets a building requirement.

Optionally, the Kalman filter model is:

X=a₀t²+v₀t+x₀

X=At+B

wherein, X represents a vector matrix of the historical operating data, t represents a time matrix, A represents a transition matrix, B represents a random term, and a₀, v₀ and x₀ represent the dynamic parameters.

optionally, the receiving module 301 is further configured for:

filtering invalid data in the historical operating data, wherein the invalid data include: at least one of an error value, a null value and a duplicate value.

optionally, the receiving module 301 is further configured for:

normalizing the historical operating data to a target data field.

According to the embodiments of the present disclosure, the shutdown operating data is predicted by the Kalman filter model built by using the historical operating data of the dry pump, so that the shutdown prediction model is trained by the obtained predicted operating data and the historical operating data, such that the shutdown prediction model may give consideration to the filtering characteristics of the Kalman filter model for noise and interference, identify the shutdown risk of the dry pump more stably, and improve the early warning accuracy of the dry pump shutdown.

The above-described apparatus embodiments are merely illustrative, wherein the units that are described as separate components may or may not be physically separate, and the components that are displayed as units may or may not be physical units; in other words, they may be located at the same one location, and may also be distributed to a plurality of network units. Part or all modules therein may be selected according to actual needs to realize the objective of achieving the technical solution of the embodiment. A person skilled in the art may understand and implement the technical solutions without paying creative work.

Each component embodiment of the present disclosure may be implemented by hardware, or by software modules that are operated on one or more processors, or by a combination thereof. A person skilled in the art should understand that some or all of the functions of some or all of the components of the computing-processing device according to the embodiments of the present disclosure may be implemented by using a microprocessor or a digital signal processor (DSP) in practice. The present disclosure may also be implemented as device or apparatus programs (for example, computer programs and computer program products) for implementing part of or the whole of the method described herein. Such programs for implementing the present disclosure may be stored in a non-transitory computer-readable medium, or may be in the form of one or more signals. Such signals may be downloaded from an Internet website, or provided on a carrier signal, or provided in any other forms.

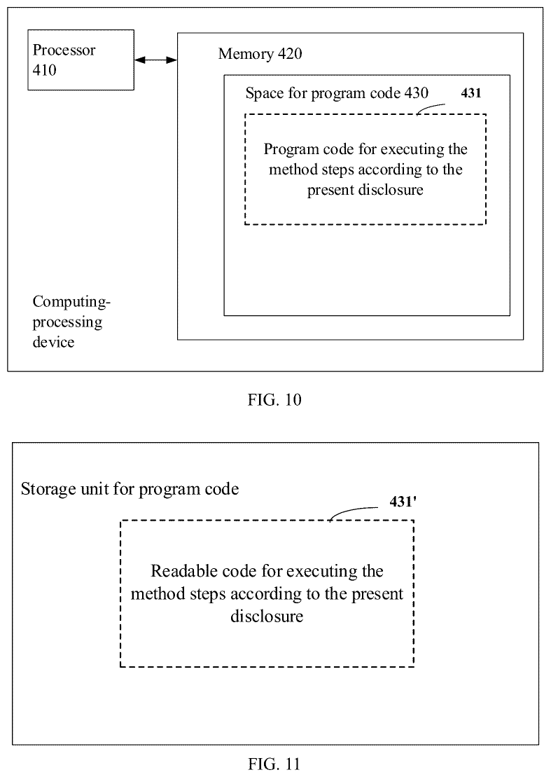

For example, FIG. 10 shows a computing-processing device that may implement the method according to the present disclosure. The computing-processing device traditionally includes a processor 410 and a computer program product or non-transitory computer-readable medium in the form of a memory 420. The memory 420 may be electronic memories such as flash memory, EEPROM (Electrically Erasable Programmable Read Only Memory), EPROM, hard disk or ROM. The memory 420 has a storage space 430 of a program code 431 for executing any of the method steps described above. For example, the storage space 430 for program code may contain program codes 431 for individually implementing each of the steps of the above method. Those program codes may be read from one or more computer program products or be written into the one or more computer program products. These computer program products include program code carriers such as hard disks, compact disks (CD), memory cards, or floppy disks. Such computer program products are usually portable or fixed storage units as shown in FIG. 11. The storage unit may have storage segments or storage spaces with similar arrangement to the memory 420 of the computing-processing device in FIG. 10. The program codes may for example be compressed in a suitable form. Generally, the storage unit contains a computer-readable code 431′, which may be read by a processor like 410. When those codes are executed by the computing-processing device, the codes cause the computing-processing device to implement each of the steps of the method described above.

It should be understood that although the steps in the flowcharts of the drawings are shown in sequence as indicated by arrows, these steps are not necessarily executed in sequence as indicated by the arrows. Unless explicitly stated herein, there is no strict sequence restriction on the execution of these steps, and these steps may be executed in other sequences. Moreover, at least a part of the steps in the drawings may include a plurality of sub-steps or stages, and these sub-steps or stages are not necessarily completed at the same time, but may be executed at different times, and the order of execution of these sub-steps or stages is not necessarily sequential, but may be executed alternately or alternately with other steps or at least a part of sub-steps of other steps or stages.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

Many details are discussed in the specification provided herein. However, it may be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present disclosure may be implemented by means of hardware comprising several different elements and by means of a properly programmed computer. In unit claims that list several devices, some of those apparatuses may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail by referring to the above embodiments, a person skilled in the art should understand that he may still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A method for early warning of dry pump shutdown, wherein the method comprises:
obtaining historical operating data of a dry pump;
building a Kalman filter model by using the historical operating data;
predicting predicted operating data of the dry pump through the Kalman filter model;
training a shutdown prediction model by using the historical operating data and the predicted operating data; and
inputting current operating data of the dry pump into the trained shutdown prediction model to obtain shutdown early warning information of the dry pump.

2. The method according to claim 1, wherein training the shutdown prediction model by using the historical operating data and the predicted operating data comprises:
identifying an operating state type of the predicted operating data;
labeling the historical operating data according to the operating state type; and
training the shutdown prediction model by using the labeled historical operating data.

3. The method according to claim 2, wherein operating state type at least comprises: a shutdown type and a normal type; and
the identifying the operating state type of the predicted operating data comprises:
when the predicted operating data exceeds a normal operating data range, determining the predicted operating data as the shutdown type; and
when the predicted operating data does not exceed the normal operating data range, determining the predicted operating data as the normal type.

4. The method according to claim 1, wherein obtaining the historical operating data of the dry pump comprises:
obtaining full operating data of the dry pump;
analyzing correlations between operating data of different dimensions in the full operating data and a shutdown event of the dry pump; and
taking the operating data of at least one dimension with the correlation meeting a correlation requirement of the shutdown event as the historical operating data.

5. The method according to claim 4, wherein analyzing the correlations between operating data of different dimensions in the full operating data and the shutdown event of the dry pump comprises:
obtaining variation trends of the operating data of different dimensions in the full operating data near a shutdown time point of the dry pump; and
determining the correlations between the operating data of different dimensions and the shutdown event of the dry pump according to variation values of the variation trends.

6. The method according to claim 4, wherein analyzing the correlations between operating data of different dimensions in the full operating data and the shutdown event of the dry pump comprises:
building a multidimensional model of the operating data of different dimensions in the full operating data;
obtaining measures of dispersion of the operating data of different dimensions in the multidimensional model; and
determining the correlations between the operating data of different dimensions and the shutdown event of the dry pump according to the measures of dispersion.

7. The method according to claim 1, wherein building the Kalman filter model by using the historical operating data comprises:
initializing dynamic parameters of the Kalman filter model; and
adjusting the dynamic parameters in the initialized Kalman filter model by using the historical operating data until an execution degree of the adjusted Kalman filter model meets a building requirement.

8. The method according to claim 7, wherein the Kalman filter model is:
X=a₀t²+V₀t+x₀
X=At+B
wherein, X represents a vector matrix of the historical operating data, t represents a time matrix, A represents a transition matrix, B represents a random term, and a₀, v₀ and x₀ represent the dynamic parameters.

9. The method according to claim 1, wherein after obtaining the historical operating data of the dry pump, the method further comprises:
filtering invalid data in the historical operating data, wherein the invalid data comprise: at least one of an error value, a null value and a duplicate value.

10. The method according to claim 1, wherein after obtaining the historical operating data of the dry pump, the method further comprises:
normalizing the historical operating data to a target data field.

11. (canceled)

12. A computing-processing device, comprising:
a memory in which a computer-readable code is stored; and
one or more processors, wherein when the computer-readable code is executed by the one or more processors, the computing-processing device executes a method for early warning of dry pump shutdown, wherein the method comprises:
obtaining historical operating data of a dry pump;
building a Kalman filter model by using the historical operating data;
predicting predicted operating data of the dry pump through the Kalman filter model;
training a shutdown prediction model by using the historical operating data and the predicted operating data; and
inputting current operating data of the dry pump into the trained shutdown prediction model to obtain shutdown early warning information of the dry pump.

13. (canceled)

14. A non-transitory computer-readable medium storing a computer program of the method for early warning of dry pump shutdown according to claim 1.

15. The device according to claim 12, wherein training the shutdown prediction model by using the historical operating data and the predicted operating data comprises:
identifying an operating state type of the predicted operating data;
labeling the historical operating data according to the operating state type; and
training the shutdown prediction model by using the labeled historical operating data.

16. The device according to claim 12, wherein obtaining the historical operating data of the dry pump comprises:
obtaining full operating data of the dry pump;
analyzing correlations between operating data of different dimensions in the full operating data and a shutdown event of the dry pump; and
taking the operating data of at least one dimension with the correlation meeting a correlation requirement of the shutdown event as the historical operating data.

17. The device according to claim 12, wherein building the Kalman filter model by using the historical operating data comprises:
initializing dynamic parameters of the Kalman filter model; and
adjusting the dynamic parameters in the initialized Kalman filter model by using the historical operating data until an execution degree of the adjusted Kalman filter model meets a building requirement.

18. The device according to claim 12, wherein after obtaining the historical operating data of the dry pump, the method further comprises:
filtering invalid data in the historical operating data, wherein the invalid data comprise: at least one of an error value, a null value and a duplicate value.

19. The device according to claim 12, wherein after obtaining the historical operating data of the dry pump, the method further comprises:
normalizing the historical operating data to a target data field.

20. The device according to claim 15, wherein operating state type at least comprises: a shutdown type and a normal type; and
the identifying the operating state type of the predicted operating data comprises:
when the predicted operating data exceeds a normal operating data range, determining the predicted operating data as the shutdown type; and
when the predicted operating data does not exceed the normal operating data range, determining the predicted operating data as the normal type.

21. The device according to claim 16, wherein analyzing the correlations between operating data of different dimensions in the full operating data and the shutdown event of the dry pump comprises:
obtaining variation trends of the operating data of different dimensions in the full operating data near a shutdown time point of the dry pump; and
determining the correlations between the operating data of different dimensions and the shutdown event of the dry pump according to variation values of the variation trends.

22. The device according to claim 16, wherein analyzing the correlations between operating data of different dimensions in the full operating data and the shutdown event of the dry pump comprises:
building a multidimensional model of the operating data of different dimensions in the full operating data;
obtaining measures of dispersion of the operating data of different dimensions in the multidimensional model; and
determining the correlations between the operating data of different dimensions and the shutdown event of the dry pump according to the measures of dispersion.
